(19) United States
(12) Patent Application Publication
(10) Pub. No.: US 2003/0070505 A1
(43) Pub. Date: Apr. 17, 2003

(54) Stub handlebar for motorcycles

(75) Inventors: Mathias Meinecke, Muenchen (DE); Robert Venus, Berlin (DE)

Correspondence Address: CROWELL & MORING LLP, INTELLECTUAL PROPERTY GROUP, P.O. BOX 14300, WASHINGTON, DC, 20044-4300, US

(73) Assignee: Bayerische Motoren Werke Aktiengesellschaft

(21) Appl. No.: 10/217,538

(22) Filed: Aug. 14, 2002

(30) Foreign Application Priority Data
Oct. 13, 2001 (DE) 101 50 703.8

(51) Int. Cl. B62K 21/12

(52) U.S. Cl. 74/551.1

(57) ABSTRACT

A stub handlebar has a handlebar grip and a handlebar holder including a tube-shaped section which is pushed into a guide bush inserted into the free end of a standpipe or fork pipe. One or more screws may be provided for axial fastening of the handlebar holder in the bush. Each such screw can be screwed radially from the outside through the fork pipe and the bush and engage in one or more recesses of the handlebar holder. In addition, protection against torsion which ensures that the handlebar holder always remains non-rotatably connected with the fork pipe is provided. An end stop is also provided and prevents unintentional pulling of the handlebar holder out of the standpipe.

This application claims the priority of German application 101 50 703.8, filed Oct. 13, 2001, the disclosure of which is expressly incorporated by reference herein.

### BACKGROUND AND SUMMARY OF THE INVENTION

The present invention relates to a stub handlebar for motorcycles including a handlebar holder which is connected with a standpipe of a motorcycle fork.

A stub handlebar for motorcycles which consists of a handlebar grip and a handlebar grip holder is known from German Patent Document DE 44 19 944 A1. At one end of the handlebar grip holder, a “mounting clip”, which is clamped to the free end of a forked tube, is provided.

Two basically different variants of motorcycle stub handlebars are known from the present applicant's own prior art. Specifically, a first variant, in which a stub handlebar is clamped to an upper fork end or a spring strut end, as in the above-mentioned German Patent Document DE 44 19 944 A1, and a second variant, in which a stub handlebar is screwed to a fork bridge connecting two forked tubes with one another, are known. The first variant, in turn, has two subvariants, specifically one with protection against torsion and another without protection against torsion. The second variant also has two subvariants, specifically one in which the stub handlebar is additionally clamped to the fork or spring strut and another in which the stub handlebar is only screwed to the fork bridge.

Furthermore, a differentiation is made between possibly adjustable stub handlebars and stub handlebars without possibility for adjustment. Adjusting devices of known stub handlebars permit adjustment longitudinally in the driving direction, in the longitudinal direction of the forked pipes or standpipes, and in almost all planes inbetween. In some motorcycles, angles between the stubs and the longitudinal vehicle axes can also be adjusted. For adjusting a stub handlebar, the fastened elements must first be released. Subsequently, the stub handlebar is displaced and the fastening elements are tightened again.

Normally, adjustment of a handlebar is made by the driver himself and not a special shop. This poses considerable safety risks with conventional handlebars. The reason for this is that, in conventional handlebars, normally, no “redundant protection” exists against torsion and adjustment of position. Thus, when the “position adjustment” is released, steering torque or force transmission to the front wheel is no longer possible. However, normally, a specific releasing of the “steering-force transmitting fastening devices” is required for handlebar adjustment. If the handlebar is subsequently not fastened properly again, a complete inability to steer the motorcycle or a crash may result.

Another disadvantage of conventional handlebar adjustments which are clamped on the outside of a forked tube or fastened to a fork bridge is the usually relatively large installation space requirement.

It is an object of the invention to provide a stub handlebar with a handlebar height which can be adjusted in a simple manner and which is safer than conventional stub handlebars.

This object is achieved by providing a handlebar holder which has a tube-shaped shaft section inserted into the standpipe. Advantageous further features of the invention are reflected in the dependent claims.

A basic principle of the invention is that a stub handlebar includes a handlebar holder and a handlebar grip, and that the handlebar holder has a tube-shaped section which is inserted into the free end of a “standpipe” or “forked pipe”. Such an arrangement requires very little installation space and has particularly advantageous design aspects.

The tube-shaped “shaft section” does not necessarily need to have a circular cross-section; as an alternative, the shaft section may, for example, have a square or polygonal cross-section.

According to a further feature of the invention, a bush is arranged in the interior of the free end of the standpipe or forked pipe and is fixedly connected with the standpipe. The bush is used as a guide for the handlebar holder.

For axial fastening of the handlebar holder in the bush, a screw, a screw-type element, or several screws or screw-type elements may be provided which are screwed radially from the outside through the forked tube and the bush and engage in one or several recesses of the handlebar holder. As an alternative, the handlebar holder can also be clamped down or tightened from “above” by means of “rubber bellows”. As another alternative, the handlebar holder may also be connected by way of a “bayonet catch” with the forked tube or the bush arranged therein.

Preferably, several spaced recesses are provided in the axial direction on the handlebar holder. These recesses form a “grid”. This means that the handlebar height is gridded or can be adjusted in predefined positions.

According to a further feature of the invention, a protection against torsion is additionally provided. This protection against torsion has the purpose of keeping the handlebar holder always non-rotatably connected with the forked tube. It is therefore ensured that the motorcycle remains steerable and the handlebar or the “handlebar receiving device” cannot be rotated against the longitudinal axis of the vehicle. The protection against torsion is conceived such that it will also be effective when the handlebar or the handlebar holder is not properly fixed in the axial direction.

This is achieved by having the handlebar holder engage in the circumferential direction form-lockingly in the bush. For this purpose, for example, an adjusting spring may be provided between the handlebar holder and the bush. The adjusting spring “blocks” the handlebar holder in the circumferential direction but permits its axial displacement or adjustment. As an alternative to an adjusting spring, splines or a serration may be provided.

When a handlebar holder which has a shaft section with a square or polygonal cross-section is used, no “additional element”, such as an adjusting spring, has to be provided at all. The reason is that, in this case, protection against torsion is already achieved by the “non-circular” cross-section of the shaft section.

Preferably, an axial end stop is additionally provided. The end stop ensures that the handlebar holder cannot be pulled out of the forked tube. For this purpose, an axially extending longitudinal groove is provided on the handlebar holder. An end stop pin which is screwed or inserted radially from the outside through the forked tube or the bush engages into the longitudinal groove. The handlebar holder can be pulled out of the forked tube until the end stop pin rests on the end of the longitudinal groove.

The longitudinal groove is preferably arranged spaced away from the protection against torsion, that is the adjusting spring, in the longitudinal direction.

The entire handlebar arrangement is provided mirror-symmetrically on the motorcycle. This means that one stub handlebar respectively is arranged in the above-described manner at the two forked tubes which are connected with one another by a fork-type bridge. In this case, for protection against torsion, the two handlebar holders can be connected with one another in the longitudinal direction of the vehicle.

Summarizing, the invention achieves the following advantages:

A visually attractive and space-saving arrangement of a stub handlebar on a motorcycle;

a redundantly safe adjusting system which, in particular, is protected from faulty operation;

easy operability as a result of the adjusting gridding which ensures a defined position of the handlebar stubs;

end stop protection against an unintentional pulling of the handlebar holder out of the standpipe; and

protection against torsion which, even when locking is released, ensures steerability of the motorcycle, that is a transmission of the steering force from the handlebar to the fork.

The invention will be explained in detail by way of an embodiment shown in the drawings.

### BRIEF DESCRIPTION OF THE DRAWINGS

FIG. 1 is a perspective view of a stub handlebar;

FIG. 2 is a top view of the stub handlebar of FIG. 1 with four different intersection lines;

FIG. 3 is a sectional view along intersection line A-A of FIG. 2;

FIG. 4 is a sectional view along intersection line B-B of FIG. 2;

FIG. 5 is a sectional view along intersection line C-C of FIG. 2; and

FIG. 6 is a sectional view along line D-D of FIG. 2.

### DETAILED DESCRIPTION OF THE INVENTION

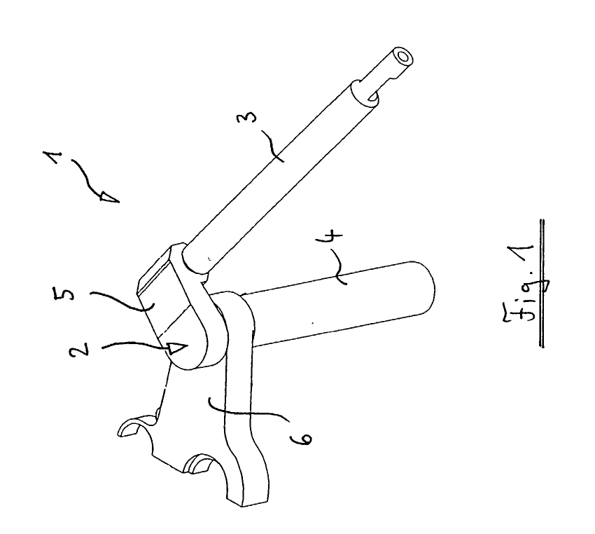

FIG. 1 illustrates a stub handlebar 1 having a handlebar holder 2 and a handlebar grip 3. Only the headpiece 5 of the handlebar holder 2, projecting out of the forked pipe or standpipe 4, is visible here. The standpipe 4 is connected by way of a plate-type fork bridge 6 with the second standpipe (not shown) of the motorcycle.

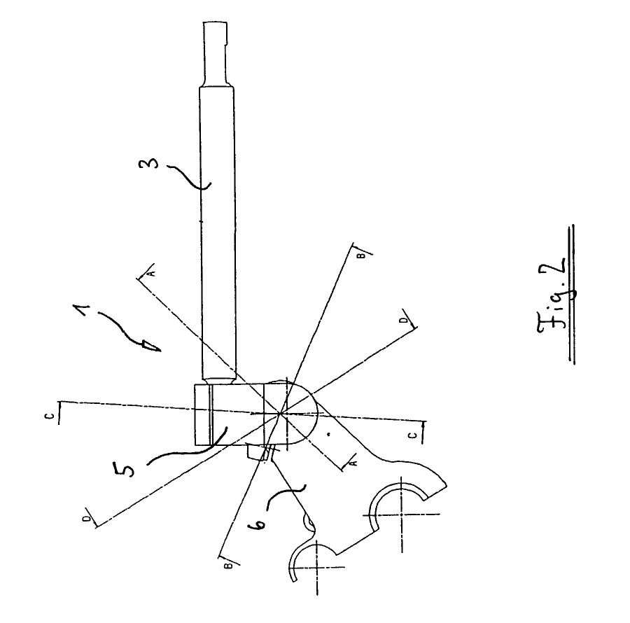

FIG. 2 is a top view of the stub handlebar 1 of FIG. 1. Also, several intersection lines A-A, B-B, C-C, D-D are shown.

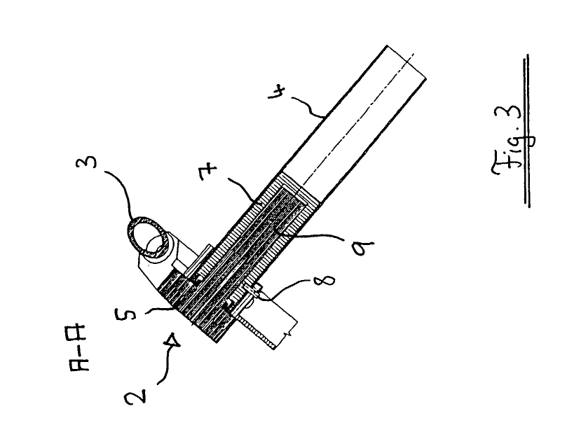

FIG. 3 is a sectional view of the stub handlebar along the intersection line A-A of FIG. 2. A guide bush 7 is inserted into the free end of the standpipe 4. The bush 7 is secured in the standpipe 4 by a radially inserted dowel pin 8. As illustrated in FIG. 3, the handlebar holder 2 has a tube-shaped shaft section 9 which is connected here in one piece with the headpiece 5 of the handlebar holder 2. In the mounted condition, the shaft section 9 is fixedly connected with the bush 7 or the standpipe 4. However, by releasing the locking devices (not shown here), the handlebar holder 2 can be axially adjusted; that is, the shaft section 9 can then be displaced in the bush 7.

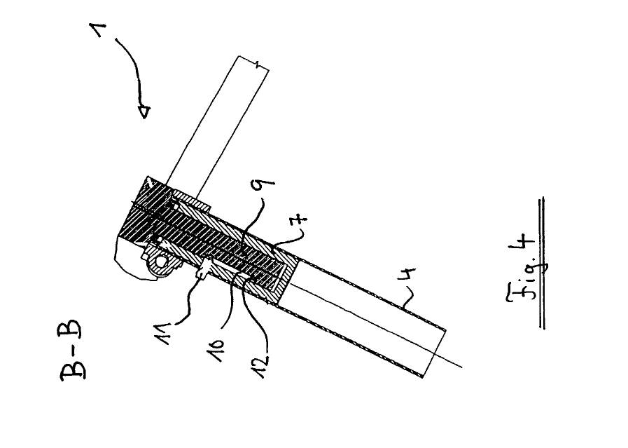

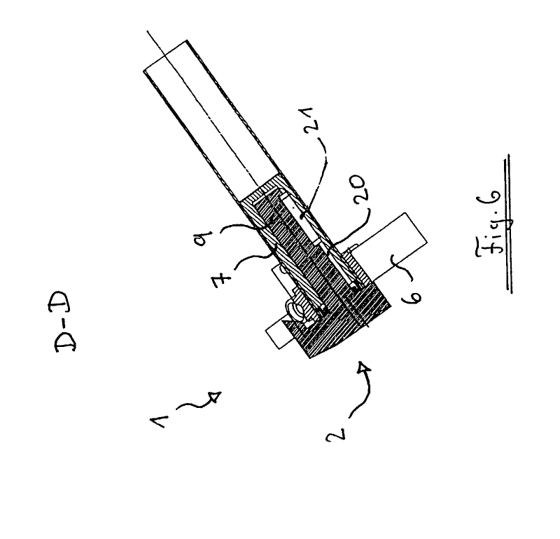

FIG. 4 is a sectional view of the stub handlebar 1 along intersection line B-B of FIG. 2. This sectional view shows the “axial end stop” of the shaft section 9 of the stub handlebar 1. The shaft section 9 has a groove 10, into which a pin 11 engages. The pin extends radially from the outside through the standpipe 4 and the bush 7 into the groove 10. The groove end 12 prevents the handlebar holder from being pulled too far out of the standpipe 4 or the bush 7 when locking is released. The “end stop” therefore ensures that the stub handlebar 1 remains connected with the standpipe 4 even when locking is released. In addition, the protection against torsion described in connection with FIG. 6 ensures that the motorcycle remains steerable when handlebar locking is released.

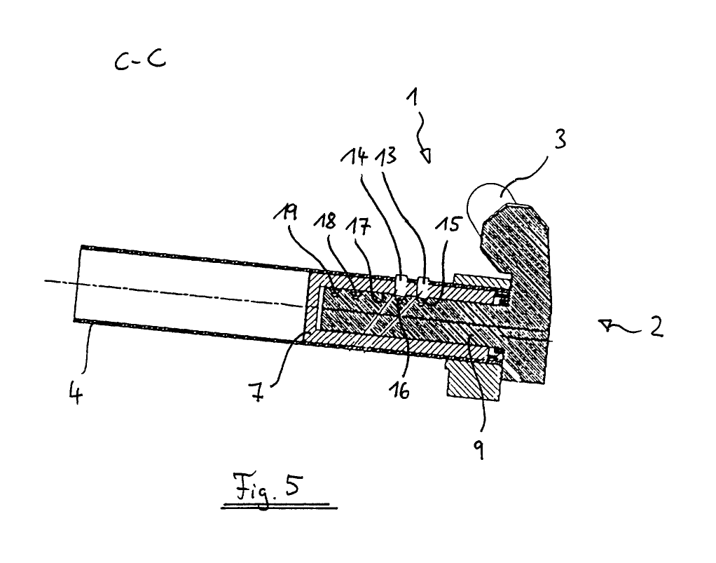

FIG. 5 is a sectional view of the stub handlebar 1 along the intersection line C-C of FIG. 2. The “locking” of the shaft section 9 of the handlebar holder 2 is illustrated in this sectional view. Here, two threaded pins 13 and 14 are provided for locking the handlebar holder 2, are screwed radially from the outside through the standpipe 4 and the bush 7, and engage in assigned recesses 15 and 16, respectively, of the shaft section 9. As illustrated in FIG. 5, three additional recesses 17 to 19 are provided along the shaft section 9. The recesses 15 to 19 therefore represent a “grid”. The stub handlebar 1 can thus be vertically adjusted in a grid-type manner.

FIG. 6 is a sectional view of the stub handlebar 1 along line D-D of FIG. 2. This sectional representation shows the “protection against torsion” of the stub handlebar 1. The bush 7 has an adjusting spring groove 20 in which an adjusting spring 21 is displaceable. The adjusting spring is inserted into a corresponding adjusting spring depression of the shaft section 9 of the handlebar holder 2. The “adjusting spring connection” ensures a “rotating coupling” of the handlebar holder 2 with the bush 7 but, simultaneously, permits an axial displacement, that is, a vertical adjustment of the stub handlebar. As alternatives to an adjusting spring connection, splines or a serration may also be provided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A stub handlebar for motorcycles comprising a handlebar holder which is connected with a standpipe of a motorcycle fork, wherein the handlebar holder has a tube-shaped shaft section which is inserted into the standpipe.

2. The stub handlebar according to claim 1, and further comprising a bush inserted into the standpipe and fixedly connected with the standpipe, wherein the handlebar holder is inserted into the bush.

3. The stub handlebar according to claim 2, wherein the handlebar holder is connected with the standpipe by releasable fastening devices, and wherein the handlebar holder can be fixed in several different axial positions with respect to the standpipe.

4. The stub handlebar according to claim 3, wherein said releasable fastening devices include at least one screw element screwed radially from outside into the standpipe or into the bush and engages form-lockingly in a radial recess of the handlebar holder.

5. The stub handlebar according to claim 4, wherein the screw element is a threaded pin.

6. The stub handlebar according to claim 3, wherein the handlebar holder has several radial recesses, spaced in an axial direction, so that the handlebar holder can be fixed in several defined positions.

7. The stub handlebar according to claim 2, and further comprising a device for protecting against torsion provided to prevent twisting of the handlebar holder relative to the standpipe so that, even in a released condition, the handlebar holder is coupled with the standpipe in a rotating direction by the device for protecting against torsion.

8. The stub handlebar according to claim 7, wherein the device for protecting against torsion has an adjusting spring which connects the handlebar holder form-lockingly in its circumferential direction with the bush.

9. The stub handlebar according to claim 8, wherein the handlebar holder has an axial end stop.

10. The stub handlebar according to claim 9, wherein the handlebar holder has a longitudinal groove, and wherein an end stop pin which radially penetrates the standpipe and the bush and which engages in the longitudinal groove is provided.

11. The stub handlebar according to claim 10, wherein the longitudinal groove is spaced from the adjusting spring in a longitudinal direction.

12. The stub handlebar according to claim 1, wherein said standpipe is one of two standpipes and said handlebar holder is one of two handlebar holders, wherein said two standpipes are connected with one another by way of a fork bridge, and wherein one of said handlebar holders is respectively inserted in each of the two standpipes.

13. The stub handlebar according to claim 12, wherein the two handlebar holders are mutually connected for protection against torsion in a longitudinal direction of the vehicle.

14. The stub handlebar according to claim 1, wherein the handlebar holder is connected with the standpipe by releasable fastening devices, and wherein the handlebar holder can be fixed in several different axial positions with respect to the standpipe.

15. The stub handlebar according to claim 14, wherein said releasable fastening devices include at least one screw element screwed radially from outside into the standpipe and engages form-lockingly in a radial recess of the handlebar holder.

16. The stub handlebar according to claim 2, wherein said standpipe is one of two standpipes and said handlebar holder is one of two handlebar holders, wherein said two standpipes are connected with one another by way of a fork bridge, and wherein one of said handlebar holders is respectively inserted in each of the two standpipes.

17. The stub handlebar according to claim 3, wherein said standpipe is one of two standpipes and said handlebar holder is one of two handlebar holders, wherein said two standpipes are connected with one another by way of a fork bridge, and wherein one of said handlebar holders is respectively inserted in each of the two standpipes.

18. The stub handlebar according to claim 4, wherein said standpipe is one of two standpipes and said handlebar holder is one of two handlebar holders, wherein said two standpipes are connected with one another by way of a fork bridge, and wherein one of said handlebar holders is respectively inserted in each of the two standpipes.

19. The stub handlebar according to claim 5, wherein said standpipe is one of two standpipes and said handlebar holder is one of two handlebar holders, wherein said two standpipes are connected with one another by way of a fork bridge, and wherein one of said handlebar holders is respectively inserted in each of the two standpipes.

20. The stub handlebar according to claim 6, wherein said standpipe is one of two standpipes and said handlebar holder is one of two handlebar holders, wherein said two standpipes are connected with one another by way of a fork bridge, and wherein one of said handlebar holders is respectively inserted in each of the two standpipes.

21. The stub handlebar according to claim 7, wherein said standpipe is one of two standpipes and said handlebar holder is one of two handlebar holders, wherein said two standpipes are connected with one another by way of a fork bridge, and wherein one of said handlebar holders is respectively inserted in each of the two standpipes.

22. The stub handlebar according to claim 8, wherein said standpipe is one of two standpipes and said handlebar holder is one of two handlebar holders, wherein said two standpipes are connected with one another by way of a fork bridge, and wherein one of said handlebar holders is respectively inserted in each of the two standpipes.

23. The stub handlebar according to claim 9, wherein said standpipe is one of two standpipes and said handlebar holder is one of two handlebar holders, wherein said two standpipes are connected with one another by way of a fork bridge, and wherein one of said handlebar holders is respectively inserted in each of the two standpipes.

24. The stub handlebar according to claim 10, wherein said standpipe is one of two standpipes and said handlebar holder is one of two handlebar holders, wherein said two standpipes are connected with one another by way of a fork bridge, and wherein one of said handlebar holders is respectively inserted in each of the two standpipes.

25. The stub handlebar according to claim 11, wherein said standpipe is one of two standpipes and said handlebar holder is one of two handlebar holders, wherein said two standpipes are connected with one another by way of a fork bridge, and wherein one of said handlebar holders is respectively inserted in each of the two standpipes.
